(19) United States
(12) Patent Application Publication
(10) Pub. No.: US 2025/0377496 A1
(43) Pub. Date: Dec. 11, 2025

(54) ANTI-RESONANT HOLLOW CORE OPTICAL FIBER

(71) Applicant: CORNING INCORPORATED, CORNING, NY (US)

(72) Inventors: Paulo Clovis Dainese, JR., Painted Post, NY (US); Klaus Hartkorn, Painted Post, NY (US); Ming-Jun Li, Horseheads, NY (US); Dan Trung Nguyen, Painted Post, NY (US); Ilia Andreyevich Nikulin, Leland, NC (US)

(21) Appl. No.: 19/225,041

(22) Filed: Jun. 2, 2025

Related U.S. Application Data
(60) Provisional application No. 63/657,272, filed on Jun. 7, 2024.

(51) Int. Cl. G02B 6/032

(52) U.S. Cl. CPC G02B 6/032

(57) ABSTRACT

An anti-resonant hollow core optical fiber including: (1) a fiber longitudinal axis; (2) a cladding tube; (3) a support ring disposed within the cladding tube comprising (i) an outer surface separated from the cladding tube by an outer space and (ii) an inner surface forming an inner space; (4) outer capillaries within the outer space (a) fused to the cladding tube and the support ring and comprising; (5) inner capillaries within the inner space fused to the support ring; and (6) an effective core region comprising a core radius that is tangential to the outer surfaces of the inner capillaries, wherein, the outer radii of the outer capillaries are all a common first value or fall within a first range that is different than a common second value or a second range within which the outer radii of the inner capillaries fall.

This application claims the benefit of priority to U.S. Provisional Patent Application Ser. No. 63/657,272 filed on Jun. 7, 2024, the content of which is relied upon and incorporated herein by reference in its entirety.

### TECHNICAL FIELD

The present disclosure generally relates to anti-resonant hollow core optical fibers and, more particularly, to anti-resonant hollow core optical fibers with improved confinement loss and manufacturability.

### BACKGROUND

Optical fibers are utilized to transmit data. More particularly, a transmitter converts information into pulses of electromagnetic radiation and transmits the pulses into the optical fiber. The electromagnetic radiation transmits along the optical fiber to a receiver. The receiver re-converts the pulses of electromagnetic radiation back into information.

Optical fiber often includes a solid core through which the electromagnetic radiation moves and a cladding surrounding the solid core to maintain the electromagnetic radiation within the solid core. The cladding and the solid core exhibit different indices of refraction, and the difference causes the electromagnetic radiation to stay generally within the solid core during transmission due to total internal reflection. The solid core of the optical fiber is often formed of silica-based glass.

Transmission performance of optical fibers with a solid core can suffer from scattering, absorption, and bending losses. The material of the solid core can scatter and absorb the electromagnetic radiation pulses that the optical fiber is transmitting. Further, despite the total internal reflection, some of the intensity of the electromagnetic radiation escapes from the core into the cladding due to external perturbations such as bending and stresses. The escape from the core is sometimes referred to as confinement loss. The scattering, absorption, and lack of confinement reduce the intensity of the electromagnetic radiation pulses. That reduces the ability of the receiver to convert the pulses back into information.

To address these losses, hollow core optical fibers have been developed. Hollow core optical fibers, as the name suggests, do not include a core of solid material. Rather, the core is a gas, such as air. Due to the absence of a solid core, it is thought that the electromagnetic radiation could transmit without as much scattering and absorption loss.

There is still the issue of confinement of the electromagnetic radiation within the core. A category of hollow core optical fibers relies upon anti-resonance between the core and the cladding to confine the electromagnetic radiation within the core rather than escaping into the cladding. Those optical fibers are sometimes referred to as anti-resonant hollow core optical fibers, or AR-HCFs for short. With AR-HCFs, the hollow core is surrounded by relatively thin glass anti-resonant cladding elements. Anti-resonance occurs when electromagnetic radiation within any of the anti-resonant cladding elements destructively interferes with itself, resulting in minimum transmission through the glass. The greater the anti-resonant effect, the greater the cladding elements confine the electromagnetic radiation within the core, and thus the lower the confinement loss.

However, there is a problem in that the anti-resonant cladding design is not one-size-fits-all. Engineering the anti-resonant cladding elements to achieve better confinement loss across desirable wavelength ranges is thus a constant endeavor. In addition, there is a problem in that AR-HCFs are difficult to manufacture. The cladding is an exacting structure where manufacturing variability can greatly affect confinement loss.

### SUMMARY

The present disclosure addresses those problems with several anti-resonant hollow core optical fiber designs that exhibit low confinement loss of electromagnetic radiation having wavelengths at or around 1550 nm. One design category includes a support ring that spatially separates outer capillaries from inner capillaries. The outer capillaries and the inner capillaries have different outer radii, with the outer radii of the outer capillaries being smaller than the outer radii of the inner capillaries. Another design category includes a support ring that spatially separates solid rods from inner capillaries. The solid rods adequately prevent leakage of the electromagnetic radiation beyond the inner capillaries and improve manufacturability compared to the outer capillaries. Still another design category includes a support ring that spatially separates two sets of outer capillaries having different radii from inner capillaries. The larger radii outer capillaries are positioned to prevent leakage of electromagnetic radiation through the gaps between the inner capillaries, while the smaller radii outer capillaries are radially aligned with the inner capillaries. All the design categories can further include nested capillaries nested within the inner capillaries to further reduce confinement loss. The anti-resonant hollow core optical fibers of all the design categories exhibit confinement loss of electromagnetic radiation at the 1550 nm wavelength that is less than an optical fiber with a solid silica core.

According to a first embodiment, an anti-resonant hollow core optical fiber comprises: (1) a fiber longitudinal axis extending from a first end to a second end; (2) a cladding tube through which the fiber longitudinal axis extends, the cladding tube (a) extending longitudinally from the first end to the second end, (b) disposed radially around the longitudinal axis, and (c) comprising (i) an outer surface at an outer radius from the fiber longitudinal axis and (ii) an inner surface at an inner radius from the fiber longitudinal axis; (3) a support ring disposed within the cladding tube and through which the fiber longitudinal axis extends, the support ring (a) extending longitudinally from the first end to the second end, (b) disposed radially around the fiber longitudinal axis, and (c) comprising (i) an outer surface at an outer radius from the fiber longitudinal axis, the outer surface separated from the inner surface of the cladding tube by an outer space, (ii) an inner surface at an inner radius from the fiber longitudinal axis, the inner surface forming an inner space, and (iii) a thickness between the outer surface and the inner surface of the support ring; (4) outer capillaries substantially evenly spaced around the fiber longitudinal axis within the outer space, each of the outer capillaries (a) fused to both the inner surface of the cladding tube and the outer surface of the support ring and (b) comprising (i) an outer longitudinal axis extending parallel to the fiber longitudinal axis from the first end to the second end, (ii) an inner surface at an inner radius from the outer longitudinal axis, (iii) an outer surface at an outer radius from the outer longitudinal axis, and (iv) a thickness between the outer surface and the inner surface of the outer capillary; (5) inner capillaries substantially evenly spaced within the inner space around the fiber longitudinal axis, each of the inner capillaries (a) fused to the inner surface of the support ring and (b) comprising (i) an inner longitudinal axis extending parallel to the fiber longitudinal axis from the first end to the second end, (ii) an inner surface at an inner radius from the inner longitudinal axis, the inner surface forming a capillary space, (iii) an outer surface at an outer radius from the inner longitudinal axis, and (iv) a thickness between the outer surface and the inner surface of the inner capillary; and (6) an effective core region through which the fiber longitudinal axis extends, the effective core region comprising a core radius from the fiber longitudinal axis that is tangential to the outer surfaces of the inner capillaries, wherein, the outer radii of the outer capillaries are all a common first value or fall within a first range that is less than a common second value or a second range within which the outer radii of the inner capillaries fall.

According to a second aspect of the present disclosure, the anti-resonant hollow core optical fiber of the first aspect is presented, wherein (i) the first value or first range of the outer radii of the outer capillaries is from 3.0 μm to 10.0 μm, (ii) the second value or second range of the outer radii of the inner capillaries is from 5.0 μm to 20 μm, and (iii) the outer radius of the support ring is within a range of from 35 μm to 60 μm.

According to a third aspect of the present disclosure, the anti-resonant hollow core optical fiber of any one of the first through second aspects is presented, wherein the thicknesses of the outer capillaries and the inner capillaries are predetermined to minimize confinement loss by establishing an anti-resonant condition for electromagnetic radiation of a predetermined wavelength or wavelength range.

According to a fourth aspect of the present disclosure, the anti-resonant hollow core optical fiber of any one of the first through third aspects is presented, wherein the anti-resonant hollow core optical fiber includes (i) from 3 to 12 outer capillaries and (ii) from 3 to 8 inner capillaries.

According to a fifth aspect of the present disclosure, the anti-resonant hollow core optical fiber of any one of the first through fourth aspects is presented, wherein compositions of the cladding tube, the support ring, the outer capillaries, and the inner capillaries all comprise a composition comprising silica glass.

According to a sixth aspect of the present disclosure, the anti-resonant hollow core optical fiber of the fifth aspect is presented, wherein the compositions of one or more of the inner capillaries, the support ring, the outer capillaries, and the cladding tube further comprise either a viscosity-raising dopant or a viscosity-lowering dopant of the silica glass.

According to a seventh aspect of the present disclosure, the anti-resonant hollow core optical fiber of any one of the first through sixth aspects is presented, wherein an inner gap separates each pair of the inner capillaries that are adjacent to each other, and the outer capillaries are positioned opposite the inner gaps between the inner capillaries.

According to an eighth aspect of the present disclosure, the anti-resonant hollow core optical fiber of any one of the first through seventh aspects further comprises nested capillaries within the capillary spaces of the inner capillaries, each of the nested capillaries (a) fused to the inner surface of a different one of the inner capillaries and (b) comprising (i) a nested longitudinal axis extending parallel to the fiber longitudinal axis from the first end to the second end, (ii) an inner surface at an inner radius from the nested longitudinal axis, (iii) an outer surface at an outer radius from the nested longitudinal axis, and (iv) a thickness between the outer surface and the inner surface of the nested capillary.

According to a ninth aspect of the present disclosure, the anti-resonant hollow core optical fiber of the eighth aspect is presented, wherein (i) the anti-resonant hollow core optical fiber includes exactly 5 outer capillaries and exactly 5 inner capillaries, (ii) the first value or the first range of the outer radii of the outer capillaries is from 6.2 μm to 6.8 μm, (iii) the thicknesses of the outer capillaries and the inner capillaries are within a range of from 340 nm to 550 nm, (iv) the outer radius of the support ring is within a range of from 40 μm to 46 μm, (v) the thickness of the support ring is within a range of from 710 nm to 770 nm, (vi) the second value or the second range of the outer radii of the inner capillaries is from 11 μm to 15 μm, (vii) the outer radii of the nested capillaries are within a range of from 6.2 μm to 6.8 μm, (viii) the thicknesses of the nested capillaries are within a range of from 340 nm to 550 nm, and (ix) the anti-resonant hollow core optical fiber exhibits a confinement loss of less than 0.010 dB/km for the fundamental mode of electromagnetic radiation having a wavelength within a range of from 1520 nm to 1580 nm.

According to a tenth aspect of the present disclosure, an anti-resonant hollow core optical fiber comprises: (1) a fiber longitudinal axis extending from a first end to a second end; (2) a cladding tube through which the fiber longitudinal axis extends, the cladding tube (a) extending longitudinally from the first end to the second end, (b) disposed radially around the longitudinal axis, and (c) comprising (i) an outer surface at an outer radius from the fiber longitudinal axis and (ii) an inner surface at an inner radius from the fiber longitudinal axis; (3) a support ring disposed within the cladding tube and through which the fiber longitudinal axis extends, the support ring (a) extending longitudinally from the first end to the second end, (b) disposed radially around the fiber longitudinal axis, and (c) comprising (i) an outer surface at an outer radius from the fiber longitudinal axis, the outer surface separated from the inner surface of the cladding tube by an outer space, (ii) an inner surface at an inner radius from the fiber longitudinal axis, the inner surface forming an inner space, and (iii) a thickness between the outer surface and the inner surface of the support ring; (4) solid rods substantially evenly spaced within the outer space around the fiber longitudinal axis, each of the solid rods (a) fused to both the inner surface of the cladding tube and the outer surface of the support ring and (b) comprising (i) an outer longitudinal axis extending parallel to the fiber longitudinal axis from the first end to the second end and (ii) an outer surface at an outer radius from the outer longitudinal axis; (5) inner capillaries substantially evenly spaced within the inner space around the fiber longitudinal axis, each of the inner capillaries (a) fused to the inner surface of the support ring and (b) comprising (i) an inner longitudinal axis extending parallel to the fiber longitudinal axis from the first end to the second end, (ii) an inner surface at an inner radius from the inner longitudinal axis, the inner surface forming a capillary space, (iii) an outer surface at an outer radius from the inner longitudinal axis, and (iv) a thickness between the outer surface and the inner surface of the inner capillary; and (6) an effective core region through which the fiber longitudinal axis extends, the effective core region comprising a core radius from the fiber longitudinal axis that is tangential to the outer surfaces of the inner capillaries.

According to an eleventh aspect of the present disclosure, the anti-resonant hollow core optical fiber of the tenth aspect is presented, wherein the thicknesses of the inner capillaries are predetermined to minimize confinement loss by establishing an anti-resonant condition for electromagnetic radiation of a predetermined wavelength or wavelength range.

According to a twelfth aspect of the present disclosure, the anti-resonant hollow core optical fiber of any one of the tenth through eleventh aspects is presented, wherein the outer radii of the solid rods have a first value or fall within a first range that is different than a second value of the outer radii of the inner capillaries or a second range within which the outer radii of the inner capillaries fall.

According to a thirteenth aspect of the present disclosure, the anti-resonant hollow core optical fiber of any one of the tenth through twelfth aspects is presented, wherein the anti-resonant hollow core optical fiber includes (i) from 3 to 12 solid rods and (ii) from 3 to 8 inner capillaries.

According to a fourteenth aspect of the present disclosure, the anti-resonant hollow core optical fiber of any one of the tenth through thirteenth aspects is presented, wherein the cladding tube, the support ring, the solid rods, and the inner capillaries all comprise a composition comprising silica glass.

According to a fifteenth aspect of the present disclosure, the anti-resonant hollow core optical fiber of the fourteenth aspects is presented, wherein the compositions of one or more of the inner capillaries, the support ring, the solid rods, and the cladding tube further comprise either a viscosity-raising dopant or a viscosity-lowering dopant of the silica glass.

According to a sixteenth aspect of the present disclosure, the anti-resonant hollow core optical fiber of any one of the tenth through fifteenth aspects is presented, wherein (i) the outer radii of the solid rods are within a range of from 3 μm to 10 μm, (ii) the outer radius of the support ring is within a range of from 35 μm to 60 μm, and (iii) the outer radii of the inner capillaries are within a range of 5 μm to 20 μm.

According to a seventeenth aspect of the present disclosure, the anti-resonant hollow core optical fiber of any one of the tenth through sixteenth aspects is presented, wherein (i) an inner gap separates each pair of the inner capillaries that are adjacent to each other, and (ii) the solid rods are positioned opposite the inner gaps between the inner capillaries.

According to an eighteenth aspect of the present disclosure, the anti-resonant hollow core optical fiber of any one of the tenth through seventeenth aspects further comprises nested capillaries within the capillary spaces of the inner capillaries, each of the nested capillaries (a) fused to the inner surface of a different one of the inner capillaries and (b) comprising (i) a nested longitudinal axis extending parallel to the fiber longitudinal axis from the first end to the second end, (ii) an inner surface at an inner radius from the nested longitudinal axis, (iii) an outer surface at an outer radius from the nested longitudinal axis, and (iv) a thickness between the outer surface and the inner surface of the nested capillary.

According to a nineteenth aspect of the present disclosure, the anti-resonant hollow core optical fiber of any one of the tenth through eighteenth aspects is presented, wherein (i) the anti-resonant hollow core optical fiber includes exactly 6 outer capillaries and exactly 6 inner capillaries, (ii) the outer radii of the solid rods are within a range of from 6.2 μm to 6.8 μm, (iii) the outer radius of the support ring is within a range of from 40 μm to 46 μm, (iv) the thickness of the support ring is within a range of from 710 nm to 770 nm, (v) the outer radii of the inner capillaries are within a range of from 11 μm to 15 μm, (vi) the thicknesses of the inner capillaries are within a range of from 340 nm to 550 nm, (vii) the outer radii of the nested capillaries are within a range of from 6.2 μm to 6.8 μm, (viii) the thicknesses of the nested capillaries are within a range of from 340 nm to 550 nm, and (ix) the anti-resonant hollow core optical fiber exhibits a confinement loss of less than 0.030 dB/km for the fundamental mode of electromagnetic radiation having a wavelength within a range of from 1520 nm to 1580 nm.

According to a twentieth aspect of the present disclosure, an anti-resonant hollow core optical fiber comprises: (1) a fiber longitudinal axis extending from a first end to a second end; (2) a cladding tube through which the fiber longitudinal axis extends, the cladding tube (a) extending longitudinally from the first end to the second end, (b) disposed radially around the fiber longitudinal axis, and (c) comprising (i) an outer surface at an outer radius from the fiber longitudinal axis and (ii) an inner surface at an inner radius from the fiber longitudinal axis; (3) a support ring disposed within the cladding tube and through which the fiber longitudinal axis extends, the support ring (a) extending longitudinally from the first end to the second end, (b) disposed radially around the fiber longitudinal axis, and (c) comprising (i) an outer surface at an outer radius from the fiber longitudinal axis, the outer surface separated from the inner surface of the cladding tube by an outer space, (ii) an inner surface at an inner radius from the fiber longitudinal axis, the inner surface forming an inner space, and (iii) a thickness between the outer surface and the inner surface of the support ring; (4) outer capillaries substantially evenly spaced within the outer space around the fiber longitudinal axis, each of the outer capillaries comprising (i) an outer longitudinal axis extending parallel to the fiber longitudinal axis from the first end to the second end, (ii) an inner surface at an inner radius from the outer longitudinal axis, (iii) an outer surface at an outer radius from the outer longitudinal axis, and (iv) a thickness between the outer surface and the inner surface of the outer capillary; (5) inner capillaries substantially evenly spaced within the inner space around the fiber longitudinal axis, each of the inner capillaries (a) fused to the inner surface of the support ring and (b) comprising (i) an inner longitudinal axis extending parallel to the fiber longitudinal axis from the first end to the second end, (ii) an inner surface at an inner radius from the inner longitudinal axis, the inner surface forming a capillary space, (iii) an outer surface at an outer radius from the inner longitudinal axis, and (iv) a thickness between the outer surface and the inner surface of the inner capillary; and (6) an effective core region through which the fiber longitudinal axis extends, the effective core region comprising a core radius from the fiber longitudinal axis that is tangential to the outer surfaces of the inner capillaries, wherein (a) the outer radii of some of the outer capillaries are all a common first value or fall within a first range and the outer radii of the other of the outer capillaries are all of a common second value or fall within a second range that is (i) smaller than the common first value or the first range and (ii) does not overlap with the first range, (b) the outer capillaries with the outer radii of the common first value or falling within the first range are fused to both the inner surface of the cladding tube and the outer surface of the support ring, and (c) the outer capillaries with the outer radii of the common second value or falling within the second range are fused to the inner surface of the cladding tube.

According to a twenty-first aspect of the present disclosure, the anti-resonant hollow core optical fiber of the twentieth aspect is presented, wherein the cladding tube, the support ring, the outer capillaries, and the inner capillaries all comprise a composition comprising silica glass.

According to a twenty-second aspect of the present disclosure, the anti-resonant hollow core optical fiber of any one of the twentieth through twenty-first aspects is presented, wherein (i) the common first value or the first range of the outer radii of the outer capillaries is from 9.25 μm to 13.00 μm, (ii) the common second value or the second range of the outer radii of the outer capillaries is from 3.00 μm to 9.25 μm, (iii) the outer radius of the support ring is within a range of from 35 μm to 60 μm, and (iv) the outer radii of the inner capillaries are within a range of 5.0 μm to 20 μm.

According to a twenty-third aspect of the present disclosure, the anti-resonant hollow core optical fiber of any one of the twentieth through twenty-second aspects is presented, wherein (i) an inner gap separates each pair of the inner capillaries that are adjacent to each other, (ii) the outer capillaries with the outer radii having the common first value or falling within the first range are positioned opposite the inner gaps between the inner capillaries, and (iii) the outer capillaries with the outer radii having the common second value or falling within the second range are positioned opposite the inner capillaries.

According to a twenty-fourth aspect of the present disclosure, the anti-resonant hollow core optical fiber of any one of the twentieth through twenty-third aspects is presented, wherein (i) the anti-resonant hollow core optical fiber includes exactly 12 outer capillaries and exactly 6 inner capillaries, (ii) the common first value or the first range of the outer radii of the outer capillaries is from 9.50 μm to 10.0 μm, (iii) the common second value or the second range of the outer radii of the outer capillaries is from 8.50 μm to 9.00 μm, (iv) the thicknesses of the outer capillaries and the inner capillaries are within a range of from 340 nm to 550 nm, (v) the outer radius of the support ring is within a range of from 40 μm to 46 μm, (vi) the thickness of the support ring is within a range of from 710 nm to 770 nm, (vii) the outer radii of the inner capillaries are within a range of from 11.0 μm to 15.0 μm, and (viii) the anti-resonant hollow core optical fiber exhibits a confinement loss of less than 0.050 dB/km for the fundamental mode of electromagnetic radiation having a wavelength within a range of from 1520 nm to 1580 nm.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 is a perspective view of an anti-resonant hollow core optical fiber of the present disclosure, illustrating a first end, a second end, and a fiber longitudinal axis extending between the first end and the second end;

FIG. 2 is an elevational view of a cross-section of an embodiment of the anti-resonant hollow core optical fiber taken through line II-II of FIG. 1, illustrating a support ring separating inner capillaries within an inner space from outer capillaries within an outer space;

FIG. 3 is an elevational view of a cross-section of an embodiment of the anti-resonant hollow core optical fiber taken through line III-III of FIG. 1, illustrating the same features as FIG. 2 but further including nested capillaries within the inner capillaries;

FIG. 4 is an elevational view of a cross-section of an embodiment of the anti-resonant hollow core optical fiber taken through line IV-IV of FIG. 1, illustrating the support ring separating the inner capillaries within the inner space from solid rods within the outer space;

FIG. 5 is an elevational view of a cross-section of an embodiment of the anti-resonant hollow core optical fiber taken through line V-V of FIG. 1, illustrating the same features as FIG. 4 but further including the nested capillaries within the inner capillaries;

FIG. 6 is an elevational view of a cross-section of an embodiment of the anti-resonant hollow core optical fiber taken through line VI-VI of FIG. 1, illustrating the support ring separating the inner capillaries within the inner space from two sets of the outer capillaries within the outer space, each of the two sets having a different outer radius;

FIG. 7 is an elevational view of a cross-section of an embodiment of the anti-resonant hollow core optical fiber taken through line VII-VII of FIG. 1, illustrating the same features as FIG. 6 but further including the nested capillaries within the inner capillaries; and

FIG. 8, pertaining to Examples 9-11, is a graph plotting confinement loss as a function of wavelength of electromagnetic radiation, illustrating (i) an embodiment of the anti-resonant hollow core optical fiber with nested capillaries (Example 10) exhibiting lower confinement loss than an embodiment of the anti-resonant hollow core optical fiber without nested capillaries (Example 9) and (ii) an embodiment of the anti-resonant hollow core optical fiber with nested capillaries with various components overlapping (Example 11)—to reflect manufacturing imprecision-exhibiting many peaks and valleys in the confinement loss as a function of wavelength of electromagnetic radiation.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

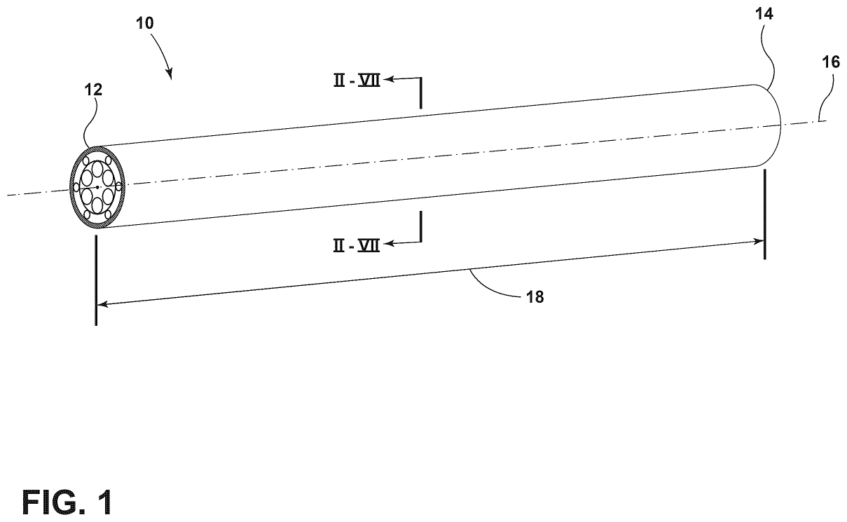

Referring to FIG. 1, an anti-resonant hollow core optical fiber 10 is herein disclosed. The anti-resonant hollow core optical fiber 10 includes a first end 12, a second end 14, and a fiber longitudinal axis 16. The fiber longitudinal axis 16 extends from the first end 12 to the second end 14. In addition, the anti-resonant hollow core optical fiber 10 has a length 18 that likewise extends from the first end 12 to the second end 14. The length 18 of the anti-resonant hollow core optical fiber 10 is not particularly important and can range from less than a meter to many kilometers. Several groupings of embodiments of the anti-resonant hollow core optical fiber 10 are now described.

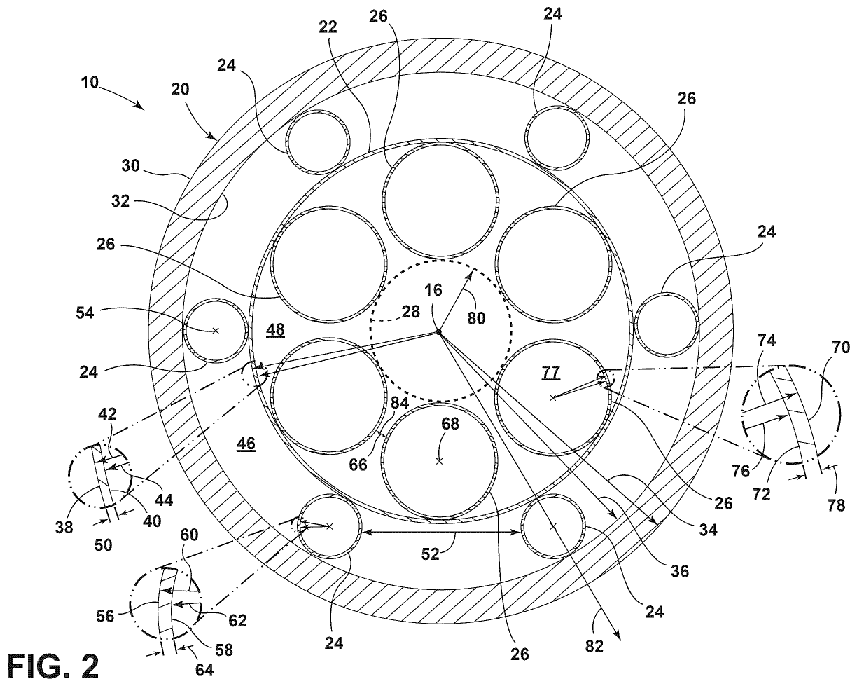

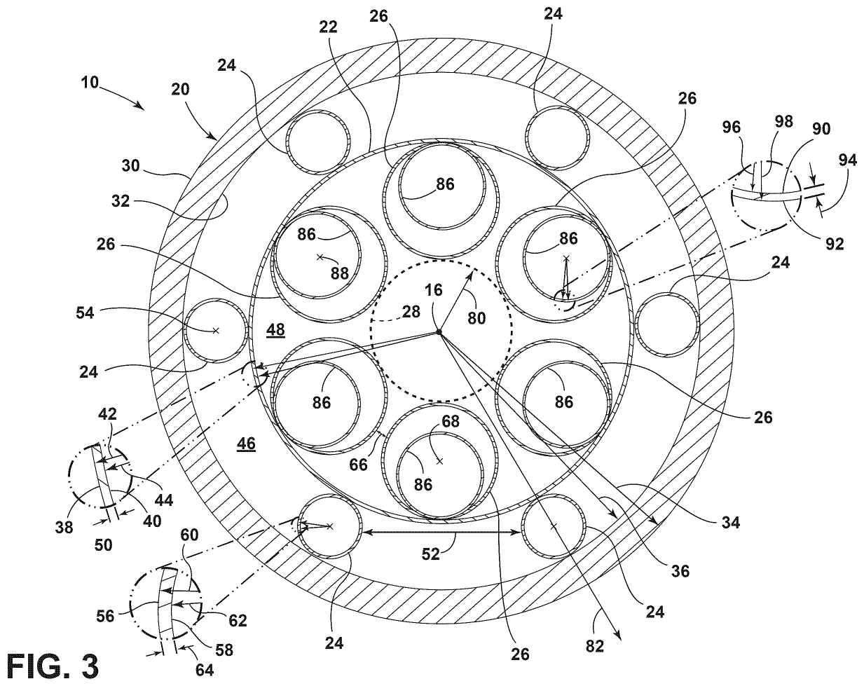

Referring now to FIGS. 2 and 3, embodiments of the anti-resonant hollow core optical fiber 10 include a cladding tube 20, a support ring 22, outer capillaries 24, inner capillaries 26, and an effective core region 28. The cladding tube 20 extends longitudinally from the first end 12 to the second end 14 of the anti-resonant hollow core optical fiber 10. The fiber longitudinal axis 16 extends through the cladding tube 20. The cladding tube 20 is disposed radially around the fiber longitudinal axis 16, as is particularly illustrated in the figures. The cladding tube 20 includes an outer surface 30 and an inner surface 32. The outer surface 30 is at an outer radius 34 from the fiber longitudinal axis 16, while the inner surface 32 is at an inner radius 36 from the fiber longitudinal axis 16. In embodiments, the inner radius 36 is within a range of from 40 μm to 75 μm. For example, the inner radius 36 can be 40 μm, 45 μm, 50 μm, 55 μm, 60 μm, 65 μm, 70 μm, 75 μm, or within any range bound by any two of those values (e.g., from 45 μm to 65 μm, from 50 μm to 60 μm, and so on).

The support ring 22 is disposed within the cladding tube 20. The support ring 22 likewise extends longitudinally from the first end 12 to the second end 14 of the anti-resonant hollow core optical fiber 10. The fiber longitudinal axis 16 extends through the support ring 22. The support ring 22 is disposed radially around the fiber longitudinal axis 16. The support ring 22 includes an outer surface 38 and an inner surface 40. The outer surface 38 is at an outer radius 42 from the fiber longitudinal axis 16, while the inner surface 40 is at an inner radius 44 from the fiber longitudinal axis 16. The outer surface 38 of the support ring 22 is separated from the inner surface 32 of the cladding tube 20 by an outer space 46. The inner surface 40 of the support ring 22 forms an inner space 48. The support ring 22 has a thickness 50 between the outer surface 38 and the inner surface 40. The support ring 22 is illustrated in the FIGS. 2 and 3 as perfectly round. However, pressure and stress effects during manufacture of the anti-resonant hollow core optical fiber 10 can deform the support ring 22 and cause the shape of the support ring 22 to deviate from the perfectly round shape to, for example, a round polygon shape. However, the functionality of the support ring 22 in shapes deviating from the perfectly round shape remain similar to the functionality of the support ring 22 having a perfectly round shape.

The outer capillaries 24 are substantially evenly spaced around the fiber longitudinal axis 16 within the outer space 46. An outer gap 52 separates each pair of the outer capillaries 24 that are adjacent to each other. The outer gaps 52 are substantially the same, such as manufactured with the intention to be the same but recognizing that manufacturing imprecision results in variations among the outer gaps 52.

Each of the outer capillaries 24 extend from the first end 12 to the second end 14 of the anti-resonant hollow core optical fiber 10 along an outer longitudinal axis 54. The outer longitudinal axes 54 are parallel to the fiber longitudinal axis 16. Each of the outer capillaries 24 is fused to both the inner surface 32 of the cladding tube 20 and the outer surface 38 of the support ring 22. Each of the outer capillaries 24 includes an outer surface 56 and an inner surface 58. The outer surface 56 is at an outer radius 60 from the outer longitudinal axis 54. The inner surface 58 is at an inner radius 62 from the outer longitudinal axis 54. Each of the outer capillaries 24 further includes a thickness 64 between the outer surface 56 and the inner surface 58 thereof.

The inner capillaries 26 are substantially evenly spaced around the fiber longitudinal axis 16 within the inner space 48. An inner gap 66 separates each pair of the inner capillaries 26 that are adjacent to each other. The inner gaps 66 are substantially the same, such as manufactured with the intention to be the same but recognizing that manufacturing imprecision results in variations among the inner gaps 66.

Each of the inner capillaries 26 extends from the first end 12 to the second end 14 of the anti-resonant hollow core optical fiber 10 along an inner longitudinal axis 68. The inner longitudinal axes 68 are parallel to the fiber longitudinal axis 16. Each of the inner capillaries 26 is fused to the inner surface 40 of the support ring 22. Each of the inner capillaries 26 includes an outer surface 70 and an inner surface 72. The outer surface 70 is at an outer radius 74 from the inner longitudinal axis 68. The inner surface 72 is at an inner radius 76 from the inner longitudinal axis 68 and defines a capillary space 77. Each of the inner capillaries 26 further includes a thickness 78 between the outer surface 70 and the inner surface 72 thereof.

The inner capillaries 26 define the effective core region 28 of the anti-resonant hollow core optical fiber 10. The fiber longitudinal axis 16 extends through the effective core region 28. The effective core region 28 extends from the first end 12 to the second end 14 of the anti-resonant hollow core optical fiber 10. The effective core region 28 includes a core radius 80 from the fiber longitudinal axis 16. The core radius 80 is tangential to the outer surfaces 70 of the inner capillaries 26.

In embodiments, such as those illustrated, the outer capillaries 24 are positioned opposite the inner gaps 66 between the inner capillaries 26. Stated another way, radial lines 82 can be conceptualized to extend outward from the fiber longitudinal axis 16. Each of the radial lines 82 extends through a different one of the inner gaps 66, and may extend through a midpoint 84 of each respective inner gaps 66. The outer capillaries 24 are positioned so that each of the radial lines 82 additionally extends through a different one of the outer capillaries 24, and may extend through the outer longitudinal axis 54 thereof.

The outer radii 60 of the outer capillaries 24 can be intended to be the same. Likewise, the outer radii 74 of the inner capillaries 26 can be intended to be the same. However, due to manufacturing limitations, the outer radii 60 of the outer capillaries 24 may vary and may not be exactly the same, and likewise the outer radii 74 of the inner capillaries 26 may vary and may not be exactly the same.

In any event, with these embodiments of FIGS. 2 and 3, the outer radii 60 of the outer capillaries 24 share a common first value (or fall within a first range) and the outer radii 74 of the inner capillaries 26 share a common second value (or fall within a second range). The common first value (or the first range) is less than the common second value (or the second range). Such an arrangement provides flexibility to optimize the dimensions of the inner space 48 and the outer space 46 to maximize the anti-resonant effects to confine the light better within in the effective core region 28. In some instances, the common first value (or the first range) of the outer radii 60 of the outer capillaries 24 is from 3.0 μm to 15.0 μm. For example, each of outer radii 60 of the outer capillaries 24 can be 3.0 μm, 3.5 μm, 4.0 μm, 4.5 μm, 5.0 μm, 5.5 μm, 6.0 μm, 6.5 μm, 7.0 μm, 7.5 μm, 8.0 μm, 8.5 μm, 9.0 μm, 9.5 μm, 10.0 μm, 10.5 μm, 11.0 μm, 11.5 μm, 12.0 μm, 12.5 μm, 13.0 μm, 13.5 μm, 14.0 μm, 14.5 μm, 15.0 μm, or within any range bound by any two of those values (e.g., from 4.0 μm to 6.5 μm, from 5.0 μm to 8.0 μm, and so on). In some instances, the common second value (or the second range) of the outer radii 74 of the inner capillaries 26 is from 5.0 μm to 20 μm. For example, each of the outer radii 74 of the inner capillaries 26 can be 5.0 μm, 6.0 μm, 7.0 μm, 8.0 μm, 9.0 μm, 10 μm, 11 μm, 12 μm, 13 μm, 14 μm, 15 μm, 16 μm, 17 μm, 18 μm, 19 μm, or 20 μm, or within any range bound by any two of those values (e.g., from 10 μm to 15 μm, from 12 μm to 19 μm, and so on).

In embodiments, the outer radius 42 of the support ring 22 is within a range of from 35 μm to 60 μm. For example, the outer radius 42 of the support ring 22 can be 35 μm, 37.5 μm, 40 μm, 42.5 μm, 45 μm, 47.5 μm, 50 μm, 52.5 μm, 55 μm, 57.5 μm, or 60 μm, or within any range bound by any two of those values (e.g., from 40 μm to 50 μm, from 37.5 μm to 42.5 μm, and so on).

In embodiments, the anti-resonant hollow core optical fiber 10 includes from 3 to 12 outer capillaries 24 and from 3 to 8 inner capillaries 26. For example, the anti-resonant hollow core optical fiber 10 can include 3, 4, 5, 6, 7, 8, 9, 10, 11, or 12 outer capillaries 24, or any number of outer capillaries 24 within any range bound by any two of those values (e.g., from 4 to 10, from 9 to 11, and so on). Likewise, the anti-resonant hollow core optical fiber 10 can include 3, 4, 5, 6, 7, or 8 inner capillaries 26, or any number of inner capillaries 26 within any range bound by any two of those values (e.g., from 4 to 7, from 3 to 6, and so on).

In embodiments, such as that illustrated at FIG. 3, the anti-resonant hollow core optical fiber 10 further includes nested capillaries 86. The nested capillaries 86 are disposed within the capillary spaces 77 of the inner capillaries 26. In particular, each of the nested capillaries 86 is disposed in a different one of the inner capillaries 26 and fused to the inner surface 72 of the respective inner capillary 26. Each of the nested capillaries 86 extends from the first end 12 to the second end 14 of the anti-resonant hollow core optical fiber 10. Each of the nested capillaries 86 includes a nested longitudinal axis 88. The nested longitudinal axis 88 extends parallel to the fiber longitudinal axis 16 from the first end 12 to the second end 14. Each of the nested capillaries 86 further includes an inner surface 90, an outer surface 92, and a thickness 94. The inner surface 90 is at an inner radius 96 from the nested longitudinal axis 88. The outer surface 92 is at an outer radius 98 from the nested longitudinal axis 88. The thickness 94 is between the outer surface 98 and the inner surface 90. The inclusion of the nested capillaries 86 can further reduce confinement loss.

In embodiments, the thicknesses 64 of the outer capillaries 24 are within a range of from 150 nm to 3000 nm. For example, the thicknesses 64 of the outer capillaries 24 can each individually be 150 nm, 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, 2000 nm, 2100 nm, 2200 nm, 2300 nm, 2400 nm, 2500 nm, 2600 nm, 2700 nm, 2800 nm, 2900 nm, 3000 nm, or within any range bound by any two of those values.

In embodiments, the thicknesses 78 of the inner capillaries 26 are within a range of from 150 nm to 3000 nm. For example, the thicknesses 78 of the inner capillaries 26 can each individually be 150 nm, 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, 2000 nm, 2100 nm, 2200 nm, 2300 nm, 2400 nm, 2500 nm, 2600 nm, 2700 nm, 2800 nm, 2900 nm, 3000 nm, or within any range bound by any two of those values.

In embodiments, the thickness 50 of the support ring 22 is within a range of from 150 nm to 3000 nm. For example, the thickness 50 of the support ring 22 can be 150 nm, 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, 2000 nm, 2100 nm, 2200 nm, 2300 nm, 2400 nm, 2500 nm, 2600 nm, 2700 nm, 2800 nm, 2900 nm, 3000 nm, or within any range bound by any two of those values.

In embodiments, the thicknesses 94 of the nested capillaries 86 are within a range of from 150 nm to 3000 nm. For example, the thicknesses 94 of the nested capillaries 86 can each individually be 150 nm, 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, 2000 nm, 2100 nm, 2200 nm, 2300 nm, 2400 nm, 2500 nm, 2600 nm, 2700 nm, 2800 nm, 2900 nm, 3000 nm, or within any range bound by any two of those values.

In embodiments, the outer radii 98 of the nested capillaries 86 are within a range of from 2.0 μm to 10.0 μm. For example, the outer radii 98 of the nested capillaries 86 can each individually be 2.0 μm, 2.5 μm, 3.0 μm, 3.5 μm, 4.0 μm, 4.5 μm, 5.0 μm, 5.5 μm, 6.0 μm, 6.5 μm, 7.0 μm, 7.5 μm, 8.0 μm, 8.5 μm, 9.0 μm, 9.5 μm, 10.0 μm, or within any range bound by any two of those values (e.g., from 3.5 μm to 6.0 μm, from 5.0 μm to 7.5 μm, and so on).

In embodiments, the thicknesses 64, 50, 78, 94 of the outer capillaries 24, the support ring 22, the inner capillaries 26, and, if included, the nested capillaries 86 are predetermined to minimize confinement loss by establishing an anti-resonant condition for electromagnetic radiation of a predetermined wavelength 18 or wavelength 18 range. For example, the thicknesses 64, 78, 94 of one or more of the outer capillaries 24, the inner capillaries 26, and the nested capillaries 86 can be calculated approximately using the following equation defining the anti-resonant condition for a flat thin glass sheet:

$$t = \frac{m λ}{4 \sqrt{{n}^{2} - 1}}$$

where m=1, 2, or 3, and so on, and is an integer corresponding to the order of anti-resonance (e.g., 1 for first order, 2 for second order, 3 for third order, and so on), 2 is the operating wavelength 18 of electromagnetic radiation, and n is the refractive index of the outer capillaries 24, inner capillaries 26, or nested capillaries 86, as the case may be. Thus, for an operating wavelength 18 of 1550 nm, a refractive index of 1.444 (e.g., pure silica at 1550 nm), and first order anti-resonance, the thicknesses 64, 78, 94 to minimize confinement loss (by maximizing anti-resonance) are each 372 nm.

Similarly, the thickness 50 of the support ring 22 to minimize confinement loss (by maximizing anti-resonance) can be calculated approximately using the following equation for a flat thin glass sheet:

$$t = \frac{( 2 m - 1 ) λ}{2 \sqrt{{n}^{2} - 1}}$$

where m=1, 2, or 3, and so on, and is an integer corresponding to the order of anti-resonance (e.g., 1 for first order, 2 for second order, 3 for third order, and so on), λ is the operating wavelength 18 of electromagnetic radiation, and n is the refractive index of the support ring 22. Thus, for an operating wavelength 18 of 1550 nm, a refractive index of 1.444, and the first order of anti-resonance, the thickness 50 to minimize confinement loss (by maximizing anti-resonance) is 744 nm.

The cladding tube 20 has a composition. The support ring 22 has a composition. The outer capillaries 24 have a composition. The inner capillaries 26 have a composition. The nested capillaries 86, if included, have a composition. The compositions of the cladding tube 20, the support ring 22, the outer capillaries 24, the inner capillaries 26, and, if included, the nested capillaries 86 can all be the same. However, they need not be. In embodiments, the compositions of the cladding tube 20, the support ring 22, the outer capillaries 24, the inner capillaries 26, and, if included, the nested capillaries 86 all include silica glass.

In embodiments, the compositions of one or more of the inner capillaries 26, the support ring 22, the outer capillaries 24, the cladding tube 20, and, if included, the nested capillaries 86 further include either a viscosity-raising dopant or a viscosity-lowering dopant of the silica glass. Predetermining the relative viscosities of the inner capillaries 26, the support ring 22, the outer capillaries 24, the cladding tube 20, and the nested capillaries 86 via their respective compositions can provide manufacturing benefits.

The one or more viscosity-raising dopants raises the viscosity of silica glass that the one or more viscosity-raising dopants dopes. In embodiments, the one or more viscosity-raising dopants includes one or more of N and ZrO₂. A particular example is doping the silica glass with N, which can form Si₃N₄. Other viscosity-raising dopants are envisioned, and that list is not exhaustive. The presence of viscosity-raising dopants within the anti-resonant hollow core optical fiber 10 can be determined using secondary ion mass spectrometry (SIMS).

The one or more viscosity-lowering dopants lowers the viscosity of silica glass that the one or more viscosity-lowering dopants dopes. In embodiments, the one or more viscosity-lowering dopants includes one or more of an alkali metal oxide, fluorine, chlorine, germania, titania, boron, phosphorus, and aluminum. A particular example is doping the silica glass with fluorine. The presence of viscosity-lowering dopants within the anti-resonant hollow core optical fiber 10 can be determined using secondary ion mass spectrometry (SIMS).

In more particular embodiments, the anti-resonant hollow core optical fiber 10 has the following parameters of this paragraph. The anti-resonant hollow core optical fiber 10 includes exactly 5 outer capillaries 24, exactly 5 inner capillaries 26, and exactly 5 nested capillaries 86. The common first value or the first range of the outer radii 60 of the outer capillaries 24 is from 6.2 μm to 6.8 μm. The thicknesses 64, 78 of the outer capillaries 24 and the inner capillaries 26 are within a range of from 340 nm to 550 nm. For example, thicknesses 64, 78 of the outer capillaries 24 and the inner capillaries 26 can separately be 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 500 nm, 510 nm, 520 nm, 530 nm, 540 nm, or 550 nm, or within any range bound by any two of those values (e.g., from 350 nm to 500 nm, from 380 nm to 520 nm, and so on). The outer radius 42 of the support ring 22 is within a range of from 40 μm to 46 μm. For example, the outer radius 42 of the support ring 22 can be 40 μm, 41 μm, 42 μm, 43 μm, 44 μm, 45 μm, or 46 μm, or within any range bound by any two of those values (e.g., from 41 μm to 43 μm, from 44 μm to 46 μm, and so on). The thickness 50 of the support ring 22 is within a range of from 710 nm to 770 nm. For example, the thickness 50 of the support ring 22 can be 710 nm, 720 nm, 730 nm, 740 nm, 750 nm, 760 nm, 770 nm, or within any range bound by any two of those values (e.g., from 720 nm to 750 nm, from 760 nm to 770 nm, and so on). The common second value or the second range of the outer radii 74 of the inner capillaries 26 is from 11 μm to 15 μm. The outer radii 98 of the nested capillaries 86 are within a range of from 6.2 μm to 6.8 μm. For example, the outer radii 98 of the nested capillaries 86 can be 6.2 μm, 6.3 μm, 6.4 μm, 6.5 μm, 6.6 μm, 6.7 μm, 6.8 μm, or within any range bound by any two of those values (e.g., from 6.2 μm to 6.5 μm, from 6.3 μm to 6.8 μm, and so on). The thicknesses 94 of the nested capillaries 86 are within a range of from 340 nm to 550 nm. For example, the thicknesses 94 of the nested capillaries 86 can each separately be 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, or within any range bound by any two of those values (e.g., from 350 nm to 530 nm, from 370 nm to 440 nm, and so on).

In embodiments, the anti-resonant hollow core optical fiber 10 exhibits a confinement loss of less than 0.300 dB/km, less than 0.250 dB/km, less than 0.200 dB/km, less than 0.100 dB/km, less than 0.050 dB/km, less than 0.040 dB/km, less than 0.030 dB/km, less than 0.020 dB/km, less than 0.010 dB/km, or less than 0.005 dB/km for the fundamental mode of electromagnetic radiation having a wavelength 18 within a range of from 1520 nm to 1580 nm. The wavelength 18 can be 1520 nm, 1530 nm, 1540 nm, 1550 nm, 1560 nm, 1570 nm, or 1580 nm, or within any range bound by any two of those values (e.g., from 1530 nm to 1560 nm, from 1520 nm to 1530 nm, and so on).

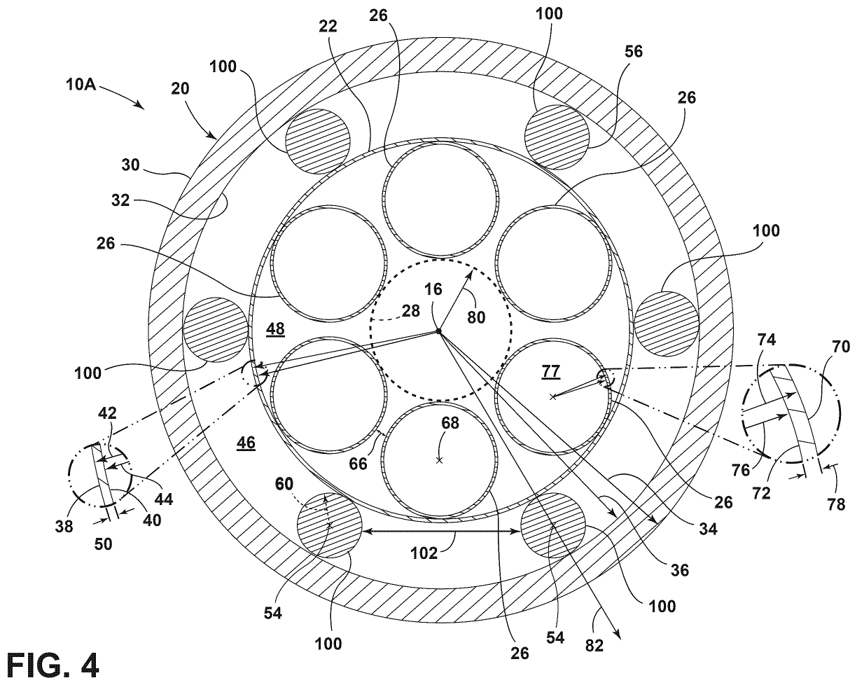

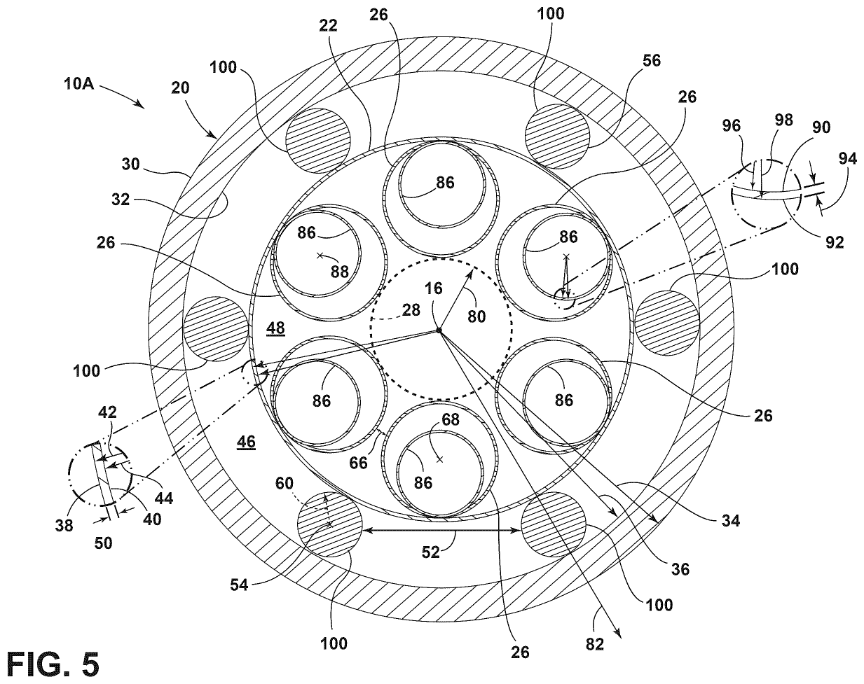

Referring now to FIGS. 4 and 5, other embodiments of the anti-resonant hollow core optical fiber 10 (hereinafter labeled 10A) are now disclosed. These embodiments share in common many of the same features as the embodiments of the anti-resonant hollow core optical fiber 10 discussed in connection with FIGS. 2 and 3. For example, the anti-resonant hollow core optical fiber 10A includes the fiber longitudinal axis 16, the cladding tube 20, the support ring 22, the inner capillaries 26, the effective core region 28, and optionally the nested capillaries 86 within the inner capillaries 26, just as the anti-resonant hollow core optical fiber 10 of FIGS. 2 and 3. The discussion of those components above apply equally as well to these embodiments of the anti-resonant hollow core optical fiber 10A.

However, instead of the outer capillaries 24, these embodiments of the anti-resonant hollow core optical fiber 10A include solid rods 100. The solid rods 100 are substantially evenly spaced around the fiber longitudinal axis 16 within the outer space 46. A rod gap 102 separates each pair of the solid rods 100 that are adjacent to each other. The rod gaps 102 are substantially the same, such as manufactured with the intention to be the same but recognizing that manufacturing imprecision results in variations among the rod gaps 102. The inclusion of the solid rods 100 does not affect confinement loss significantly (compared to inclusion of the outer capillaries 24 instead) but simplifies manufacturing, because the solid rods 100 are stronger and easier to handle than the outer capillaries 24 and provide more rigid support structure to the anti-resonant hollow core optical fiber 10A and preform from which the anti-resonant hollow core optical fiber 10A is drawn. In embodiments, like the outer capillaries 24 discussed above, the solid rods 100 are positioned opposite the inner gaps 66 between the inner capillaries 26.

Each of the solid rods 100 is fused to both the inner surface 32 of the cladding tube 20 and the outer surface 38 of the support ring 22. Each of the solid rods 100 includes an outer longitudinal axis 54 and an outer surface 56. Each of the solid rods 100 extends from the first end 12 to the second end 14 of the anti-resonant hollow core optical fiber 10, with the outer longitudinal axis 54 extending parallel to the fiber longitudinal axis 16. The outer surface 56 is at an outer radius 60 from the outer longitudinal axis 54.

The discussion above in connection with the embodiments of FIGS. 2 and 3 regarding values for the thicknesses 50, 78, 94 of the support ring 22, the inner capillaries 26, and, if included, the nested capillaries 86 pertains equally as well to the embodiments of FIGS. 4 and 5. Similarly, the discussion above in connection with the embodiments of FIGS. 2 and 3 regarding values for the outer radius 42 of the support ring 22 and the outer radii 98 of the nested capillaries 86 pertains equally as well to the embodiments of FIGS. 4 and 5. In embodiments, the thicknesses 78 of the inner capillaries 26 are predetermined to minimize confinement loss for electromagnetic radiation of a predetermined wavelength 18 or wavelength 18 range.

In embodiments, the outer radii 60 of the solid rods 100 share a common first value or fall within a first range. The outer radii 74 of the inner capillaries 26 share a common second value or fall within a second range. The common first value, or the first range, can be different and not overlapping with the common second value, or the second range. In other instances, the common first value (or the first range) and the common second value (or the second range) are the same or overlap.

In embodiments, the anti-resonant hollow core optical fiber 10A includes from 3 to 12 solid rods 100. For example, the number of the solid rods 100 of the anti-resonant hollow core optical fiber 10A can be 3, 4, 5, 6, 7, 8, 9, 10, 11, 12, or within any range bound by any two of those values (e.g., from 4 to 10, from 5 to 11). In embodiments, the anti-resonant hollow core optical fiber 10A includes from 3 to 8 inner capillaries 26. For example, the number of the inner capillaries 26 can be 3, 4, 5, 6, 7, 8, or within any range bound by any two of those values (e.g., from 4 to 7, from 3 to 5, and so on).

The solid rods 100 have a composition, which can include silica glass. In addition, the solid rods 100 can include either a viscosity-raising dopant or a viscosity-lowering dopant.

In embodiments, the outer radii 60 of the solid rods 100 are within a range of from 3.0 μm to 15.0 μm. For example, the outer radii 60 of the solid rods 100 can each separately be 3.0 μm, 3.5 μm, 4.0 μm, 4.5 μm, 5.0 μm, 5.5 μm, 6.0 μm, 6.5 μm, 7.0 μm, 7.5 μm, 8.0 μm, 8.5 μm, 9.0 μm, 9.5 μm, 10.0 μm, 10.5 μm, 11.0 μm, 11.5 μm, 12.0 μm, 12.5 μm, 13.0 μm, 13.5 μm, 14.0 μm, 14.5 μm, 15.0 μm, or within any range bound by any two of those values (e.g., from 3.0 μm to 8.0 μm, from 4.5 μm to 9.5 μm, and so on). In embodiments, the outer radii 74 of the inner capillaries 26 are within a range of 5.0 μm to 20 μm. For example, the outer radii 74 of the inner capillaries 26 can each separately be 5.0 μm, 6.0 μm, 7.0 μm, 8.0 μm, 9.0 μm, 10 μm, 11 μm, 12 μm, 13 μm, 14 μm, 15 μm, 16 μm, 17 μm, 18 μm, 19 μm, or 20 μm, or within any range bound by any two of those values (e.g., from 11 μm to 17 μm, from 18 μm to 20 μm, and so on).

In more particular embodiments, the anti-resonant hollow core optical fiber 10A has the following parameters of this paragraph. In these embodiments, the anti-resonant hollow core optical fiber 10A includes exactly 6 of the solid rods 100, exactly 6 of the inner capillaries 26, and exactly 6 of the nested capillaries 86. The outer radii 60 of the solid rods 100 are within a range of from 6.2 μm to 6.8 μm. For example, the outer radii 60 of the solid rods 100 can each separately be 6.2 μm, 6.3 μm, 6.4 μm, 6.5 μm, 6.6 μm, 6.7 μm, 6.8 μm, or within any range bound by any two of those values (e.g., from 6.3 μm to 6.6 μm, from 6.4 μm to 6.7 μm, and so on). The outer radius 42 of the support ring 22 is within a range of from 40 μm to 46 μm. For example, the outer radius 42 of the support ring 22 can be 40 μm, 41 μm, 42 μm, 43 μm, 44 μm, 45 μm, or 46 μm, or within any range bound by any two of those values (e.g., from 41 μm to 43 μm, from 44 μm to 46 μm, and so on). The thickness 50 of the support ring 22 is within a range of from 710 nm to 770 nm. For example, the thickness 50 of the support ring 22 can be 710 nm, 720 nm, 730 nm, 740 nm, 750 nm, 760 nm, 770 nm, or within any range bound by any two of those values (e.g., from 710 nm to 740 nm, from 730 nm to 760 nm, and so on). The outer radii 74 of the inner capillaries 26 are within a range of from 11 μm to 15 μm. For example, the outer radii 74 of the inner capillaries 26 can separately be 11 μm, 11.5 μm, 12 μm, 12.5 μm, 13 μm, 13.5 μm, 14 μm, 14.5 μm, 15 μm, or within any range bound by any two of those values (e.g., from 11.5 μm to 13 μm, from 12.5 μm to 13.5 μm, and so on). The thicknesses 78 of the inner capillaries 26 are within a range of from 340 nm to 550 nm. For example, the thickness 78 of the inner capillaries 26 can each separately be 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, or within any range bound by any two of those values (e.g., from 380 nm to 530 nm, from 400 nm to 480 nm, and so on). The outer radii 98 of the nested capillaries 86 are within a range of from 6.2 μm to 6.8 μm. For example, the outer radii 98 of the nested capillaries 86 can separately be 6.2 μm, 6.3 μm, 6.4 μm, 6.5 μm, 6.6 μm, 6.7 μm, 6.8 μm, or within any range bound by any two of those values (e.g., from 6.3 μm to 6.6 μm, from 6.6 μm to 6.8 μm, and so on). The thicknesses 94 of the nested capillaries 86 are within a range of from 340 nm to 550 nm. For example, the thicknesses 94 of the nested capillaries 86 can each separately be 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, or within any range bound by any two of those values (e.g., from 410 nm to 530 nm, from 440 nm to 470 nm, and so on).

In embodiments, the anti-resonant hollow core optical fiber 10A exhibits a confinement loss of less than 0.300 dB/km, less than 0.250 dB/km, less than 0.200 dB/km, less than 0.100 dB/km, less than 0.050 dB/km, less than 0.040 dB/km, less than 0.030 dB/km, less than 0.020 dB/km, less than 0.010 dB/km, or less than 0.005 dB/km for the fundamental mode of electromagnetic radiation having a wavelength 18 within a range of from 1520 nm to 1580 nm. The wavelength 18 can be 1520 nm, 1530 nm, 1540 nm, 1550 nm, 1560 nm, 1570 nm, or 1580 nm, or within any range bound by any two of those values (e.g., from 1530 nm to 1560 nm, from 1520 nm to 1530 nm, and so on).

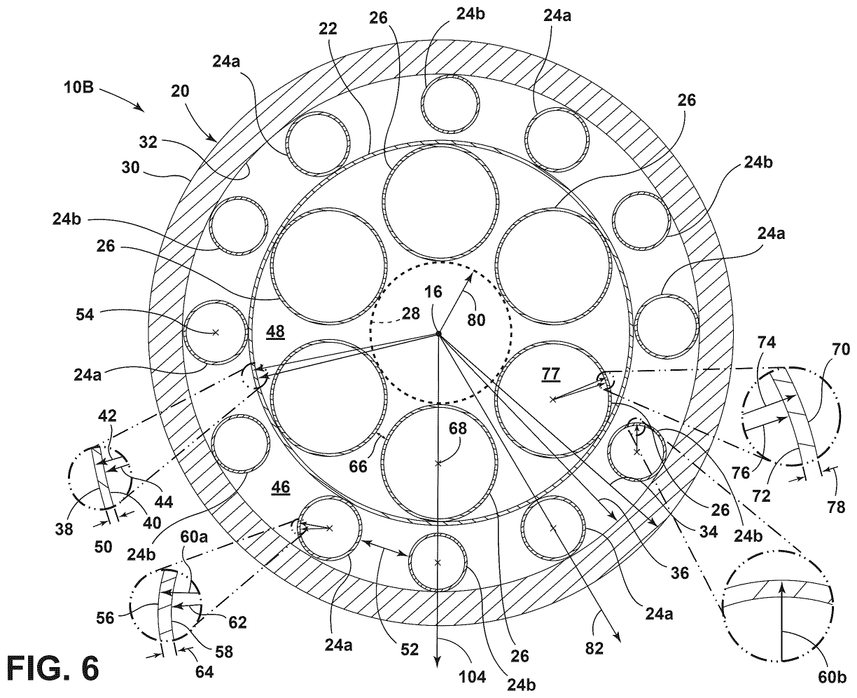

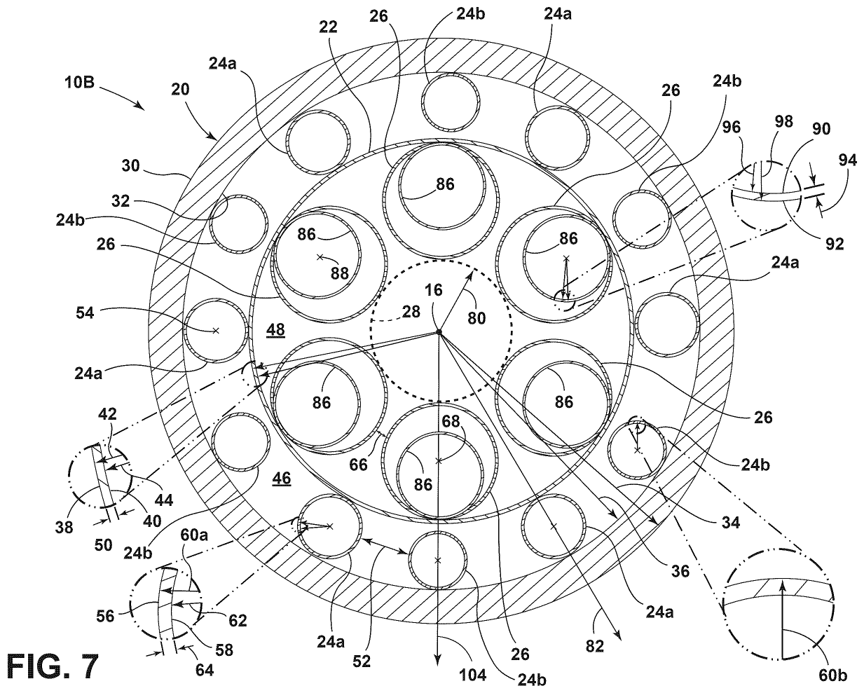

Referring now to FIGS. 6 and 7, other embodiments of the anti-resonant hollow core optical fiber 10 (hereinafter labeled 10B) are now disclosed. These embodiments share in common many of the same features as the embodiments of the anti-resonant hollow core optical fiber 10 discussed in connection with FIGS. 2 and 3. For example, the anti-resonant hollow core optical fiber 10B includes the fiber longitudinal axis 16, the cladding tube 20, the support ring 22, the inner capillaries 26, and the effective core region 28, and optionally the nested capillaries 86 within the inner capillaries 26, just as the anti-resonant hollow core optical fiber 10 of FIGS. 2 and 3. The discussion of those components above apply equally as well to these embodiments of the anti-resonant hollow core optical fiber 10B. However, in these embodiments of the anti-resonant hollow core optical fiber 10B, the outer radii 60 of some of the outer capillaries 24 (hereinafter outer radii 60a of outer capillaries 24a) share a common first value or fall within a first range, while the outer radii 60 of the other of the outer capillaries 24 (hereinafter outer radii 60b of outer capillaries 24b) share a common second value or fall within a second range. The common first value (or the first range) and the second common value (or the second range) are not the same and do not overlap. In addition, the common second value (or the second range) is smaller than the common first value (or the first range). The outer capillaries 24a that share the common first value (or falling within the first range) are fused to both the inner surface 32 of the cladding tube 20 and the outer surface 38 of the support ring 22. The outer capillaries 24b sharing the common second value (or falling within second range) are fused to the inner surface 32 of the cladding tube 20 and may not be fused to the support ring 22.

In embodiments, like the solid rods 100 above, the outer capillaries 24a with the outer radii 60a sharing the common first value (or falling within the first range) are positioned opposite the inner gaps 66 between the inner capillaries 26. In contrast, the outer capillaries 24b with the outer radii 60b sharing the common second value (or falling within the second range) are positioned opposite the inner capillaries 26. Stated another way, second radial lines 104 can be conceptualized to extend outward from the fiber longitudinal axis 16. Each of the second radial lines 104 extends through inner longitudinal axis 68 of a different one of the inner capillaries 26. The outer capillaries 24b with the outer radii 60b sharing the common second value (or falling within the second range) are positioned so that each of the second radial lines 104 additionally extends through the outer longitudinal axis 54 of a different one of the outer capillaries 24b with the outer radii 60b sharing the common second value (or falling within the second range). In contrast, radial lines 82 extend through both the inner gaps 66 between the inner capillaries 26 and the outer capillaries 24a with the outer radii 60a sharing the first common value (or falling within the first range), such as through the longitudinal axis 54 thereof.

In embodiments, the common first value (or the first range) of the outer radii 60a of the outer capillaries 24a is from 5.0 μm to 15.00 μm. For example, the outer radii 60a of the outer capillaries 24a defining the common first value (or the first range) can be 5.00 μm, 5.50 μm, 6.00 μm, 6.50 μm, 7.00 μm, 7.50 μm, 8.00 μm, 8.50 μm, 9.00 μm, 9.25 μm, 9.50 μm, 9.75 μm, 10.00 μm, 10.25 μm, 10.50 μm, 10.75 μm, 11.00 μm, 11.25 μm, 11.50 μm, 11.75 μm, 12.00 μm, 12.25 μm, 12.50 μm, 12.75 μm, 13.00 μm, 13.50 μm, 14.00 μm, 14.50 μm, 15.00 μm, or within any range bound by any two of those values (e.g., from 9.50 μm to 11.00 μm, from 9.75 μm to 11.50 μm, and so on).

In embodiments, the common second value (or the second range) of the outer radii 60b of the outer capillaries 24b is from 3.00 μm to 12.00 μm. For example, the outer radii 60b of the outer capillaries 24b defining the second value (or the second range) can be 3.00 μm, 3.50 μm, 4.00 μm, 4.50 μm, 5.00 μm, 5.50 μm, 6.00 μm, 6.50 μm, 7.00 μm, 7.50 μm, 8.00 μm, 8.50 μm, 9.00 μm, 9.25 μm, 9.50 μm, 9.75 μm, 10.00 μm, 10.25 μm, 10.50 μm, 10.75 μm, 11.00 μm, 11.25 μm, 11.50 μm, 11.75 μm, 12.00 μm, or within any range bound by any two of those values (e.g., from 3.50 μm to 5.50 μm, from 6.00 μm to 9.00 μm, and so on).

The discussion above in connection with the embodiments of FIGS. 2 and 3 regarding values for the thicknesses 64, 50, 78, 94 of the outer capillaries 24, the support ring 22, the inner capillaries 26, and, if included, the nested capillaries 86 pertains equally as well to the embodiments of FIGS. 6 and 7. Similarly, the discussion above in connection with the embodiments of FIGS. 2 and 3 regarding values for the outer radius 42 of the support ring 22, the outer radii 74 of the inner capillaries 26, and the outer radii 98 of the nested capillaries 86 pertains equally as well to the embodiments of FIGS. 6 and 7. In embodiments, the thicknesses 64, 50, 78, 94 of the outer capillaries 24a, 24b, the support ring 22, the inner capillaries 26, and, if included, the nested capillaries 86 are predetermined to minimize confinement loss for electromagnetic radiation of a predetermined wavelength 18 or wavelength 18 range.

In more particular embodiments, the anti-resonant hollow core optical fiber 10B has the following parameters of this paragraph. In these embodiments, the anti-resonant hollow core optical fiber 10B includes exactly 12 of the outer capillaries 24a, 24b and exactly 6 of the inner capillaries 26. Of the 12 outer capillaries 24a, 25b, the outer radii 60a of 6 of them share the common first value (or are within the first range) and the outer radii 60b of 6 of them share the common second value (or are within the second range). The common first value (or the first range) of the outer radii 60a of the outer capillaries 24a is from 9.50 μm to 10.0 μm. For example, the outer radii 60a of the outer capillaries 24a defining the common first value (or the first range) can each separately be 9.50 μm, 9.60 μm, 9.70 μm, 9.80 μm, 9.90 μm, 10.0 μm, or within any range bound by any two of those values (e.g., from 9.50 μm to 9.90 μm, from 9.70 μm to 9.90 μm, and so on). The second common value (or the second range) of the outer radii 60b of the outer capillaries 24b is from 8.50 μm to 9.00 μm. For example, the outer radii 60b of the outer capillaries 24b defining the common second value (or the second range) can each separately be 8.50 μm, 8.60 μm, 8.70 μm, 8.80 μm, 8.90 μm, 9.00 μm or within any range bound by any two of those values (e.g., from 8.50 μm to 8.70 μm, from 8.60 μm to 8.80 μm, and so on). The thicknesses 64, 78 of the outer capillaries 24a, 24b and the inner capillaries 26 are within a range of from 340 nm to 550 nm. For example, the thicknesses 64, 78 of the outer capillaries 24a, 24b and the inner capillaries 26 can each separately be 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, or within any range bound by any two of those values (e.g., from 480 nm to 540 nm, from 370 nm to 510 nm, and so on). The outer radius 42 of the support ring 22 is within a range of from 40 μm to 46 μm. For example, the outer radius 42 of the support ring 22 can be 40 μm, 41 μm, 42 μm, 43 μm, 44 μm, 45 μm, 46 μm, or within any range bound any two of those values (e.g., from 40 μm to 44 μm, from 41 μm to 46 μm, and so on). The thickness 50 of the support ring 22 is within a range of from 710 nm to 770 nm. For example, the thickness 50 of the support ring 22 can be 710 nm, 720 nm, 730 nm, 740 nm, 750 nm, 760 nm, 770 nm, or within any range bound by any two of those values (e.g., from 720 nm from 750 nm, from 730 nm to 770 nm, and so on). The outer radii 74 of the inner capillaries 26 are within a range of from 11.0 μm to 15.0 μm. For example, the outer radii 74 of the inner capillaries 26 can be 11.0 μm, 11.5 μm, 12.0 μm, 12.5 μm, 13.0 μm, 13.5 μm, 14.0 μm, 14.5 μm, 15.0 μm, or within any range bound by any two of those values (e.g., from 11.5 μm to 14.0 μm, from 12.0 μm to 14.5 μm, and so on).

In embodiments, the anti-resonant hollow core optical fiber 10B exhibits a confinement loss of less than 0.300 dB/km, less than 0.250 dB/km, less than 0.200 dB/km, less than 0.100 dB/km, less than 0.050 dB/km, less than 0.040 dB/km, less than 0.030 dB/km, less than 0.020 dB/km, less than 0.010 dB/km, or less than 0.005 dB/km for the fundamental mode of electromagnetic radiation having a wavelength 18 within a range of from 1520 nm to 1580 nm. The wavelength 18 can be 1520 nm, 1530 nm, 1540 nm, 1550 nm, 1560 nm, 1570 nm, or 1580 nm, or within any range bound by any two of those values (e.g., from 1530 nm to 1560 nm, from 1520 nm to 1530 nm, and so on).

The embodiments of the anti-resonant hollow core optical fibers 10, 10A, 10B of the present disclosure address the problems presented in the Background, in a variety of ways. Among them, the inclusion of both the outer capillaries 24 (or the outer capillaries 24a, 24b, or the solid rods 100, as the case may be) and the inner capillaries 26 lower confinement loss compared to anti-resonant hollow core optical fibers 10 that include just one grouping of capillaries at a predetermined radius from the fiber longitudinal axis 16. Indeed, all but one of the confinement losses presented in the Examples that follow are below that of an optical fiber with a solid silica core (for the fundamental mode at 1550 nm).

Without being bound by theory, it is believed that the outer capillaries 24 (or the outer capillaries 24a, 24b, or the solid rods 100, as the case may be) and the air gap in the outer space 46 reduce leakage of the electromagnetic radiation transmitting through the anti-resonant hollow core optical fiber 10 beyond the inner capillaries 26. In addition, the inclusion of the support ring 22 radially separating the outer capillaries 24 (or the outer capillaries 24a, 24b, or the solid rods 100, as the case may be) from the inner capillaries 26 reduces loss sensitivity due to the outer capillaries 24 (or the outer capillaries 24a, 24b, or the solid rods 100, as the case may be) and the inner capillaries 26 moving out of their intended respective spatial orientations during manufacture of the anti-resonant hollow core optical fiber 10. The inclusion of the support ring 22 provides the added benefit of further reducing confinement loss. The inclusion of the solid rods 100 in place of the outer capillaries 24 (or the outer capillaries 24a, 24b, as the case may be) further eases manufacturability.

### Examples

Examples 1-8—Eight anti-resonant hollow core optical fibers according to the present disclosure of different designs were subjected to analysis using finite element software (COMSOL). Confinement loss for the fundamental mode (or LP01 mode using linear polarization approximation) of electromagnetic radiation having a wavelength of 1550 nm was determined via the computer modeling for each of the eight designs. In addition, confinement loss for the first higher order mode (or LP11 mode using linear polarization approximation) at 1550 nm was determined. Further, the software calculated the extinction ratio. The extinction ratio is the ratio of the loss of the first higher order mode at 1550 nm to the loss of the fundamental mode at 1550 nm.

The parameters of the exemplary anti-resonant hollow core optical fibers and the modeling results are set forth in the Table below.

| Parameter | Ex. 1 | Ex. 2 | Ex. 3 | Ex. 4 | Ex. 5 | Ex. 6 | Ex. 7 | Ex. 8 |
|---|---|---|---|---|---|---|---|---|
| Number of outer capillaries | 6 | 6 | 6 | 5 | 6 | 6 | 12 | 12 |
| Number of inner capillaries | 6 | 6 | 6 | 5 | 6 | 6 | 6 | 6 |
| Outer capillary outer radius (μm) | 6.5 | 6.5 | 6.5 | 6.5 | 6.5 | 6.5 | 7.15 | 9.75 |
| Outer capillary thickness (nm) | 370 | 370 | 0 | 370 | 500 | 500 | 370 | 370 |
| Outer capillary outer radius (μm) | na | na | na | na | na | na | 6.5 | 8.73 |
| Outer capillary thickness (nm) | na | na | na | na | na | na | 370 | 370 |
| Support ring radius (μm) | 43.5 | 43.5 | 43.5 | 41 | 43.5 | 43.5 | 43.5 | 43.5 |
| Support ring thickness (nm) | 740 | 740 | 740 | 740 | 740 | 1150 | 740 | 740 |
| Inner capillary outer radius (μm) | 13 | 13 | 13 | 13 | 13 | 13 | 13 | 13 |
| Inner capillary thickness (nm) | 370 | 370 | 370 | 370 | 500 | 500 | 370 | 370 |
| Nested capillary outer radius (μm) | na | 6.5 | 6.5 | 6.5 | 6.5 | 6.5 | na | na |
| Nested capillary thickness (nm) | na | 370 | 370 | 370 | 500 | 500 | na | na |
| Loss of the fundamental mode (LP01) at | 0.20 | 0.01 | 0.02 | 0.007 | 0.004 | 0.02 | 0.05 | 0.03 |
| 1550 nm (dB/km) | | | | | | | | |
| Loss of the 1^{st} higher order modes (LP11) | 321 | 83 | 1.7 | 36 | 0.12 | 12 | 253 | 1.3 |
| at 1550 nm (dB/km) | | | | | | | | |
| Higher order mode extinction ratio | 1605 | 8300 | 85 | 5142 | 32 | 600 | 5060 | 43 |

Example 1, arranged according to FIG. 2, included an equal number of inner capillaries and outer capillaries. No nested capillaries were included. Each of the outer capillaries had the same outer radius (e.g., a first value) and each of the inner capillaries had the same outer radius (e.g., a second value). The outer radius of the outer capillaries was half the value of the outer radius of the inner capillaries. The thicknesses of the outer capillaries, the inner capillaries, and the support ring were set to be around the anti-resonant condition for the operating wavelength of 1550 nm. The model determined that the confinement loss of the fundamental mode would be 0.20 dB/km.

Example 2 was the same as Example 1 but further included nested capillaries within the inner capillaries, as illustrated at FIG. 3. The thicknesses of the nested capillaries were all set again around the anti-resonant condition for the operating wavelength of 1550 nm. The model determined that the confinement loss of the fundamental mode would be 0.01 dB/km, which is a large decrease over Example 1, showing the importance of nested capillaries.

Example 3 was the same as Example 2, but solid rods replaced the outer capillaries as illustrated at FIG. 5. The radii of the solid rods were the same as the outer radii of the outer capillaries of Example 2. The model determined that the confinement loss of the fundamental mode would be 0.02 dB/km, which is a minor increase over Example 2. However, the presence of the solid rods instead of outer capillaries would ease manufacturing of an anti-resonant hollow core optical fiber of this design.

Example 4 was the same as Example 2 but included 5 rather than 6 substantially equally spaced outer capillaries, 5 rather than 6 substantially equally spaced inner capillaries, and a slightly smaller support ring. The model determined that the confinement loss of the fundamental mode would be 0.007 dB/km, which is a decrease over Example 2. Example 4, among other things, shows that a greater number of outer capillaries and inner capillaries does not necessarily translate to better confinement loss.

Example 5 was the same as Example 2, but the thicknesses of the outer capillaries, the inner capillaries, and the nested capillaries were increased to 500 nm (compared to 370 nm in Example 2). The model determined that the confinement loss of the fundamental mode would be 0.004 dB/km, which is a decrease over Examples 2 and the lowest among the examples herein. Increasing the thicknesses, as mentioned above, resulted in a lower confinement loss because the nested capillaries generate nodes that cause an oscillation effect.

Example 6 was the same as Example 5, but the thickness of the support ring was increased from 740 nm to 1150 nm. The model determined that the confinement loss of the fundamental mode would be 0.02 dB/km, which is an increase over Example 5.

Example 7, arranged according to FIG. 6, included 12 outer capillaries and 6 inner capillaries. Of the 12 outer capillaries, 6 had an outer radius of a first common value of 7.15 μm and the other 6 had an outer radius of a second common value of 6.5 μm. The thicknesses of the nested capillaries were all set again around the anti-resonant condition for the operating wavelength of 1550 nm. The model determined that the confinement loss of the fundamental mode would be 0.05 dB/km, which is lower than Example 1 without the inclusion of nested capillaries.

Example 8 was the same as Example 7 but increased the outer radii of the 6 larger radii outer capillaries to 9.75 μm and increased the outer radii of the 6 smaller radii outer capillaries to 8.73 μm. The model determined that the confinement loss of the fundamental mode would be 0.03 dB/km, which is lower than Example 7.

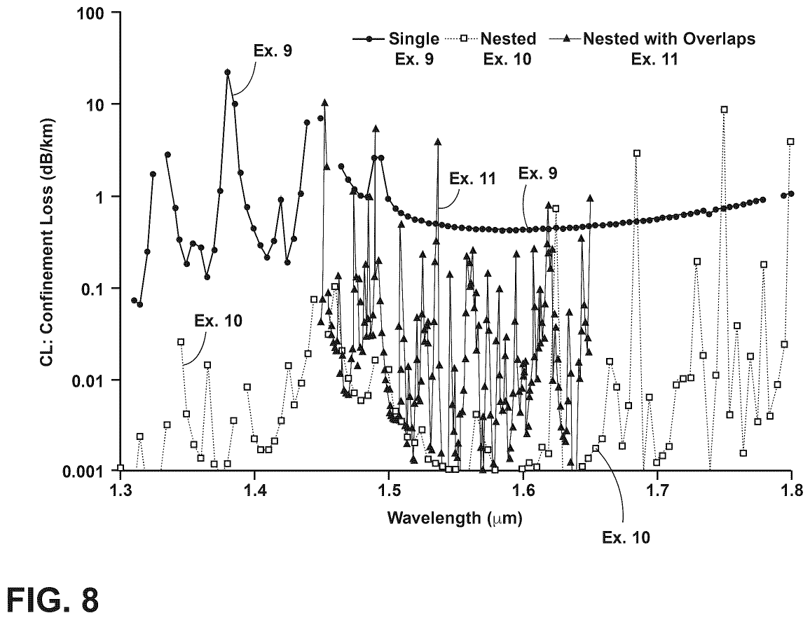

Examples 9-11—For Examples 9-11, finite element analysis modeling was again utilized to determine confinement loss as a function of wavelength of electromagnetic radiation for anti-resonant hollow core optical fibers of different designs (but according to the present disclosure). A graph plotting the results is reproduced at FIG. 8.

The layout of Example 9 was that of FIG. 2 and assumed an outer diameter for the inner capillaries of 27.5 μm, an outer diameter of the outer capillaries of 13 μm, thicknesses for the inner capillaries and the outer capillaries of 0.37 μm, a thickness of the support ring of 0.74 μm, and an outer diameter of the support ring to provide a diameter of the effective core region of 34.5 μm. As FIG. 8 shows, the layout of Example 9 exhibits a smooth response to wavelength in a wide window from 1.5 mm to 1.8 mm. The window can be centered around the target wavelength of 1550 nm with minor design changes.

The layout of Example 10 was that of FIG. 3 and thus further included nested capillaries. Example 10 assumed an outer diameter for the inner capillaries of 27.5 μm, an outer diameter of the outer capillaries of 13 μm, an outer diameter of the nested capillaries of 13 μm, thicknesses for the inner capillaries, the outer capillaries, and the nested capillaries of 0.50 μm, a thickness of the support ring of 0.74 μm, and an outer diameter of the support ring to provide a diameter of the effective core region of 34.5 μm. As FIG. 8 shows, the addition of the nested capillaries reduces the confinement loss by orders of magnitude, to be below 0.01 dB/km at multiple wavelengths. However, the spectrum becomes noisier with isolated peaks, which can go above 1 dB/km. It is expected that a real optical fiber will have wider yet lower peaks, making the loss acceptable in a relatively wide range of wavelengths.

These modeling results for Examples 9 and 10, as well as the results presented in the table above for Examples 1-8, were obtained for idealized structures with no overlaps between capillaries.

Example 11 was configured to ascertain the impact of possible capillary overlaps on the confinement loss. The overlaps are akin to those that might occur during the manufacture of a real optical fiber. The layout of Example 11 was that of Example 10 but assumed an overlap between the inner capillaries and the support ring of 0.3 μm, an overlap between the inner capillaries and the nested capillaries of 0.4 μm, and an overlap between the outer capillaries and the support ring of 0.1 μm. The modeling study of Examples 8-11 was performed with fine (1 nm) wavelength steps. The results presented in FIG. 8 for Example 11 show that geometrical imperfections create parasitic light leakage paths, which lead to a large number of narrow peaks in confinement loss. However, since the design of Example 11 takes advantage of nested capillaries, the overall loss values remain relatively low, less than 0.1 dB/km for most of the wavelengths. Thus, adequate performance with low losses can be expected for this design. Overall, even though the nested design with (Example 11) and without (Example 10) overlaps exhibits a noisy wavelength response, the calculated Confinement Loss values remain relatively low and may be acceptable for practical applications.

It will be apparent to those skilled in the art that various modifications and variations can be made without departing from the spirit or scope of the claims.

What is claimed is:

1. An anti-resonant hollow core optical fiber comprising:
a fiber longitudinal axis extending from a first end to a second end;
a cladding tube through which the fiber longitudinal axis extends, the cladding tube (a) extending longitudinally from the first end to the second end, (b) disposed radially around the longitudinal axis, and (c) comprising (i) an outer surface at an outer radius from the fiber longitudinal axis and (ii) an inner surface at an inner radius from the fiber longitudinal axis;
a support ring disposed within the cladding tube and through which the fiber longitudinal axis extends, the support ring (a) extending longitudinally from the first end to the second end, (b) disposed radially around the fiber longitudinal axis, and (c) comprising (i) an outer surface at an outer radius from the fiber longitudinal axis, the outer surface separated from the inner surface of the cladding tube by an outer space, (ii) an inner surface at an inner radius from the fiber longitudinal axis, the inner surface forming an inner space, and (iii) a thickness between the outer surface and the inner surface of the support ring;
outer capillaries substantially evenly spaced around the fiber longitudinal axis within the outer space, each of the outer capillaries (a) fused to both the inner surface of the cladding tube and the outer surface of the support ring and (b) comprising (i) an outer longitudinal axis extending parallel to the fiber longitudinal axis from the first end to the second end, (ii) an inner surface at an inner radius from the outer longitudinal axis, (iii) an outer surface at an outer radius from the outer longitudinal axis, and (iv) a thickness between the outer surface and the inner surface of the outer capillary;
inner capillaries substantially evenly spaced within the inner space around the fiber longitudinal axis, each of the inner capillaries (a) fused to the inner surface of the support ring and (b) comprising (i) an inner longitudinal axis extending parallel to the fiber longitudinal axis from the first end to the second end, (ii) an inner surface at an inner radius from the inner longitudinal axis, the inner surface forming a capillary space, (iii) an outer surface at an outer radius from the inner longitudinal axis, and (iv) a thickness between the outer surface and the inner surface of the inner capillary; and
an effective core region through which the fiber longitudinal axis extends, the effective core region comprising a core radius from the fiber longitudinal axis that is tangential to the outer surfaces of the inner capillaries,
wherein, the outer radii of the outer capillaries are all a common first value or fall within a first range that is less than a common second value or a second range within which the outer radii of the inner capillaries fall.

2. The anti-resonant hollow core optical fiber of claim 1, wherein the first value or first range of the outer radii of the outer capillaries is from 3.0 μm to 10.0 μm, the second value or second range of the outer radii of the inner capillaries is from 5.0 μm to 20 μm, and the outer radius of the support ring is within a range of from 35 μm to 60 μm.

3. The anti-resonant hollow core optical fiber of claim 1, wherein the anti-resonant hollow core optical fiber includes (i) from 3 to 12 outer capillaries and (ii) from 3 to 8 inner capillaries.

4. The anti-resonant hollow core optical fiber of claim 1, wherein compositions of the cladding tube, the support ring, the outer capillaries, and the inner capillaries all comprise a composition comprising silica.

5. The anti-resonant hollow core optical fiber of claim 1, wherein an inner gap separates each pair of the inner capillaries that are adjacent to each other, and the outer capillaries are positioned opposite the inner gaps between the inner capillaries.

6. The anti-resonant hollow core optical fiber of claim 1, further comprising:
nested capillaries within the capillary spaces of the inner capillaries, each of the nested capillaries (a) fused to the inner surface of a different one of the inner capillaries and (b) comprising (i) a nested longitudinal axis extending parallel to the fiber longitudinal axis from the first end to the second end, (ii) an inner surface at an inner radius from the nested longitudinal axis, (iii) an outer surface at an outer radius from the nested longitudinal axis, and (iv) a thickness between the outer surface and the inner surface of the nested capillary.

7. An anti-resonant hollow core optical fiber comprising:
a fiber longitudinal axis extending from a first end to a second end;
a cladding tube through which the fiber longitudinal axis extends, the cladding tube (a) extending longitudinally from the first end to the second end, (b) disposed radially around the longitudinal axis, and (c) comprising (i) an outer surface at an outer radius from the fiber longitudinal axis and (ii) an inner surface at an inner radius from the fiber longitudinal axis;
a support ring disposed within the cladding tube and through which the fiber longitudinal axis extends, the support ring (a) extending longitudinally from the first end to the second end, (b) disposed radially around the fiber longitudinal axis, and (c) comprising (i) an outer surface at an outer radius from the fiber longitudinal axis, the outer surface separated from the inner surface of the cladding tube by an outer space, (ii) an inner surface at an inner radius from the fiber longitudinal axis, the inner surface forming an inner space, and (iii) a thickness between the outer surface and the inner surface of the support ring;
solid rods substantially evenly spaced within the outer space around the fiber longitudinal axis, each of the solid rods (a) fused to both the inner surface of the cladding tube and the outer surface of the support ring and (b) comprising (i) an outer longitudinal axis extending parallel to the fiber longitudinal axis from the first end to the second end and (ii) an outer surface at an outer radius from the outer longitudinal axis;
inner capillaries substantially evenly spaced within the inner space around the fiber longitudinal axis, each of the inner capillaries (a) fused to the inner surface of the support ring and (b) comprising (i) an inner longitudinal axis extending parallel to the fiber longitudinal axis from the first end to the second end, (ii) an inner surface at an inner radius from the inner longitudinal axis, the inner surface forming a capillary space, (iii) an outer surface at an outer radius from the inner longitudinal axis, and (iv) a thickness between the outer surface and the inner surface of the inner capillary; and
an effective core region through which the fiber longitudinal axis extends, the effective core region comprising a core radius from the fiber longitudinal axis that is tangential to the outer surfaces of the inner capillaries.

8. The anti-resonant hollow core optical fiber of claim 7, wherein the thicknesses of the inner capillaries are predetermined to minimize confinement loss by establishing an anti-resonant condition for electromagnetic radiation of a predetermined wavelength or wavelength range.

9. The anti-resonant hollow core optical fiber of claim 7, wherein the outer radii of the solid rods have a first value or fall within a first range that is different than a second value of the outer radii of the inner capillaries or a second range within which the outer radii of the inner capillaries fall.

10. The anti-resonant hollow core optical fiber of claim 7, wherein the anti-resonant hollow core optical fiber includes (i) from 3 to 12 solid rods and (ii) from 3 to 8 inner capillaries.

11. The anti-resonant hollow core optical fiber of claim 7, wherein the cladding tube, the support ring, the solid rods, and the inner capillaries all comprise a composition comprising silica.

12. The anti-resonant hollow core optical fiber of claim 11, wherein the compositions of one or more of the inner capillaries, the support ring, the solid rods, and the cladding tube further comprise either a viscosity-raising dopant or a viscosity-lowering dopant.

13. The anti-resonant hollow core optical fiber of claim 7, wherein
the outer radii of the solid rods are within a range of from 3 μm to 10 μm,
the outer radius of the support ring is within a range of from 35 μm to 60 μm, and
the outer radii of the inner capillaries are within a range of 5 μm to 20 μm.

14. The anti-resonant hollow core optical fiber of claim 7, wherein an inner gap separates each pair of the inner capillaries that are adjacent to each other, and the solid rods are positioned opposite the inner gaps between the inner capillaries.

15. The anti-resonant hollow core optical fiber of claim 7, further comprising:
nested capillaries within the capillary spaces of the inner capillaries, each of the nested capillaries (a) fused to the inner surface of a different one of the inner capillaries and (b) comprising (i) a nested longitudinal axis extending parallel to the fiber longitudinal axis from the first end to the second end, (ii) an inner surface at an inner radius from the nested longitudinal axis, (iii) an outer surface at an outer radius from the nested longitudinal axis, and (iv) a thickness between the outer surface and the inner surface of the nested capillary.

16. The anti-resonant hollow core optical fiber of claim 15, wherein
the anti-resonant hollow core optical fiber includes exactly 6 outer capillaries and exactly 6 inner capillaries,
the outer radii of the solid rods are within a range of from 6.2 μm to 6.8 μm,
the outer radius of the support ring is within a range of from 40 μm to 46 μm,
the thickness of the support ring is within a range of from 710 nm to 770 nm,
the outer radii of the inner capillaries are within a range of from 11 μm to 15 μm,
the thicknesses of the inner capillaries are within a range of from 340 nm to 550 nm,
the outer radii of the nested capillaries are within a range of from 6.2 μm to 6.8 μm,
the thicknesses of the nested capillaries are within a range of from 340 nm to 550 nm, and
the anti-resonant hollow core optical fiber exhibits a confinement loss of less than 0.030 dB/km for the fundamental mode of electromagnetic radiation having a wavelength within a range of from 1520 nm to 1580 nm.

17. An anti-resonant hollow core optical fiber comprising:
a fiber longitudinal axis extending from a first end to a second end;
a cladding tube through which the fiber longitudinal axis extends, the cladding tube (a) extending longitudinally from the first end to the second end, (b) disposed radially around the fiber longitudinal axis, and (c) comprising (i) an outer surface at an outer radius from the fiber longitudinal axis and (ii) an inner surface at an inner radius from the fiber longitudinal axis;
a support ring disposed within the cladding tube and through which the fiber longitudinal axis extends, the support ring (a) extending longitudinally from the first end to the second end, (b) disposed radially around the fiber longitudinal axis, and (c) comprising (i) an outer surface at an outer radius from the fiber longitudinal axis, the outer surface separated from the inner surface of the cladding tube by an outer space, (ii) an inner surface at an inner radius from the fiber longitudinal axis, the inner surface forming an inner space, and (iii) a thickness between the outer surface and the inner surface of the support ring;
outer capillaries substantially evenly spaced within the outer space around the fiber longitudinal axis, each of the outer capillaries comprising (i) an outer longitudinal axis extending parallel to the fiber longitudinal axis from the first end to the second end, (ii) an inner surface at an inner radius from the outer longitudinal axis, (iii) an outer surface at an outer radius from the outer longitudinal axis, and (iv) a thickness between the outer surface and the inner surface of the outer capillary;
inner capillaries substantially evenly spaced within the inner space around the fiber longitudinal axis, each of the inner capillaries (a) fused to the inner surface of the support ring and (b) comprising (i) an inner longitudinal axis extending parallel to the fiber longitudinal axis from the first end to the second end, (ii) an inner surface at an inner radius from the inner longitudinal axis, the inner surface forming a capillary space, (iii) an outer surface at an outer radius from the inner longitudinal axis, and (iv) a thickness between the outer surface and the inner surface of the inner capillary; and
an effective core region through which the fiber longitudinal axis extends, the effective core region comprising a core radius from the fiber longitudinal axis that is tangential to the outer surfaces of the inner capillaries,
wherein, the outer radii of some of the outer capillaries are all a common first value or fall within a first range and the outer radii of the other of the outer capillaries are all of a common second value or fall within a second range that is (i) smaller than the common first value or the first range and (ii) does not overlap with the first range,
wherein, the outer capillaries with the outer radii of the common first value or falling within the first range are fused to both the inner surface of the cladding tube and the outer surface of the support ring, and
wherein, the outer capillaries with the outer radii of the common second value or falling within second range are fused to the inner surface of the cladding tube.

18. The anti-resonant hollow core optical fiber of claim 17, wherein
the common first value or the first range of the outer radii of the outer capillaries is from 9.25 μm to 13.00 μm,
the common second value or the second range of the outer radii of the outer capillaries is from 3.00 μm to 9.25 μm,
the outer radius of the support ring is within a range of from 35 μm to 60 μm, and
the outer radii of the inner capillaries are within a range of 5.0 μm to 20 μm.

19. The anti-resonant hollow core optical fiber of claim 17, wherein
an inner gap separates each pair of the inner capillaries that are adjacent to each other,
the outer capillaries with the outer radii having the common first value or falling within the first range are positioned opposite the inner gaps between the inner capillaries, and
the outer capillaries with the outer radii having the common second value or falling within the second range are positioned opposite the inner capillaries.

20. The anti-resonant hollow core optical fiber of claim 17, wherein
the anti-resonant hollow core optical fiber includes exactly 12 outer capillaries and exactly 6 inner capillaries,
the common first value or the first range of the outer radii of the outer capillaries is from 9.50 μm to 10.0 μm,
the common second value or the second range of the outer radii of the outer capillaries is from 8.50 μm to 9.00 μm,
the thicknesses of the outer capillaries and the inner capillaries are within a range of from 340 nm to 550 nm,
the outer radius of the support ring is within a range of from 40 μm to 46 μm,
the thickness of the support ring is within a range of from 710 nm to 770 nm,
the outer radii of the inner capillaries are within a range of from 11.0 μm to 15.0 μm, and
the anti-resonant hollow core optical fiber exhibits a confinement loss of less than 0.050 dB/km for the fundamental mode of electromagnetic radiation having a wavelength within a range of from 1520 nm to 1580 nm.
